(19) United States
(12) Patent Application Publication
(10) Pub. No.: US 2007/0244266 A1
(43) Pub. Date: Oct. 18, 2007

(54) Method for the Production of Polyvinyl Acetals

(75) Inventor: Andreas Lumpp, Sao Paulo (BR)

Correspondence Address: BROOKS KUSHMAN P.C., 1000 TOWN CENTER, TWENTY-SECOND FLOOR, SOUTHFIELD, MI, 48075, US

(73) Assignee: WACKER POLYMER SYSTEMS GMBH & CO. KG, Burghausen (DE)

(21) Appl. No.: 11/570,142

(22) PCT Filed: Jun. 23, 2005
(86) PCT No.: PCT/EP05/06818

§ 371 Date: Dec. 7, 2006

(30) Foreign Application Priority Data
Jul. 1, 2004 (DE) 10 2004 031 971.5

(51) Int. Cl. C08F 8/28

(52) U.S. Cl. 525/385

(57) ABSTRACT

Polyvinyl acetals with a high degree of acetalization and low solution viscosity are prepared by acetalizing partly or fully hydrolyzed polyvinyl ester polymers dissolved or slurried in aldehyde.

The invention relates to a process for preparing polyvinyl acetals by means of acetalization of partly hydrolysed or fully hydrolysed vinyl ester polymers, and to the use of the thus obtainable process products.

The preparation of polyvinyl acetals from the corresponding polyvinyl alcohols by polymer-like reaction with the corresponding aldehydes has been known since 1924, and a multitude of aldehydes have been used to prepare the corresponding polyvinyl acetals in the time since. Polyvinyl acetals are prepared in a 3-stage process (polyvinyl acetate→polyvinyl alcohol→polyvinyl acetal) which results in products which, in addition to vinyl acetal groups, also contain vinyl alcohol and vinyl acetate units. Commercial significance has been gained in particular by polyvinyl formal, polyvinyl acetal and polyvinyl butyral.

In the last step of the abovementioned 3-stage process, the corresponding partly hydrolysed or fully hydrolysed vinyl ester polymers are acetalized by reaction with the corresponding aldehyde. In general, these reactants are taken up in an aqueous medium. After addition of acidic catalysts such as hydrochloric acid, sulphuric acid or phosphoric acid, the acetalization reaction is started by addition of the aldehyde. After the addition of the aldehyde has been completed, the acetalization is completed by heating the mixture to 20 to 60° C. and stirring it for several hours, and the reaction product which precipitates out in pulverulent form is isolated by filtration.

This procedure is problematic especially in the case of sparingly water-soluble vinyl alcohol copolymers. The standard process of the acetalization in an aqueous medium is also found to be unsuitable for the synthesis of acetals having high degrees of acetalization (>80% by weight), since the precipitation of the acetal removes it from the further reaction. JP 05230129A describes a process for the synthesis of a polyvinyl acetal having a high degree of acetalization, in which solvent mixtures comprising dimethyl sulphoxide are used.

It is therefore an object of the invention to develop a process by which sparingly water-soluble reactants can also be acetalized with a satisfactory result.

The invention provides a process for preparing polyvinyl acetals by means of acetalization, with one or more aldehydes from the group consisting of aliphatic and aromatic aldehydes having 1 to 15 carbon atoms, of partly hydrolysed or fully hydrolysed vinyl ester polymers of one or more monomers from the group consisting of vinyl esters of unbranched or branched alkylcarboxylic acids having 1 to 15 carbon atoms with ≧50 mol % of vinyl alcohol units, characterized in that the partly hydrolysed or fully hydrolysed vinyl ester polymers are initially charged in solution or in slurry in the aldehyde.

Suitable vinyl esters are vinyl esters of unbranched or branched carboxylic acids having 1 to 15 carbon atoms. Preferred vinyl esters are vinyl acetate, vinyl propionate, vinyl butyrate, vinyl 2-ethylhexanoate, vinyl laurate, vinyl pivalate and vinyl esters of α-branched monocarboxylic acids having 5 to 11 carbon atoms, for example VeoVa9® or VeoVa10® (trade names of Resolution). Preference is given to vinyl acetate.

The vinyl ester polymers may optionally also contain one or more monomers from the group consisting of methacrylic esters and acrylic esters of alcohols having 1 to 15 carbon atoms, olefins, dienes, vinylaromatics and vinyl halides. In that case, their proportion is such that the vinyl ester proportion in the copolymer is ≧50 mol %.

The vinyl ester polymers optionally also contain 0.02 to 20% by weight, based on the total weight of the vinyl ester polymer, of one or more monomers from the group consisting of ethylenically unsaturated monocarboxylic acids, ethylenically unsaturated carboxamides and carbonitriles.

The vinyl ester polymers may be prepared in a known manner; preferably by bulk polymerization, suspension polymerization or by polymerization in organic solvents, more preferably in alcoholic solution. Suitable solvents and regulators are, for example, methanol, ethanol, propanol, isopropanol. The polymerization is carried out under reflux at a temperature of 50° C. to 100° C. and is free-radically initiated by addition of common initiators. Examples of common initiators are percarbonates such as cyclohexyl peroxodicarbonate or peresters such as t-butyl perneodecanoate or t-butyl perpivalate. The molecular weight can be adjusted in a known manner by addition of regulator, by the solvent content, by variation of the initiator concentration and by variation of the temperature. After the polymerization has been completed, the solvent and any excess monomer and regulator are distilled off.

The vinyl ester polymers are hydrolysed in a manner known per se, for example by the belt or kneader process, under alkaline or acidic conditions with addition of acid or base. The solid vinyl ester resin is preferably taken up in alcohol, for example methanol, with establishment of a solids content of 15 to 70% by weight. Preference is given to carrying out the hydrolysis under basic conditions, for example by addition of NaOH, KOH or NaOCH₃. The base is used generally in an amount of 1 to 5 mol % per mole of ester units. The hydrolysis is carried out at temperatures of 30° C. to 70° C. After the hydrolysis has been completed, the solvent is distilled off and the polyvinyl alcohol is obtained as a powder.

The thus obtained partly or fully hydrolysed vinyl ester polymers have a degree of hydrolysis of ≧50 mol %. Preferred ranges for the partly hydrolysed polyvinyl alcohols are degrees of hydrolysis of 70 to 90 mol %. Particular preference is given to fully hydrolysed polyvinyl alcohols having a degree of hydrolysis of ≧96 mol %.

The acetalization is effected in one or more aldehydes from the group consisting of aliphatic and aromatic aldehydes having 1 to 15 carbon atoms. Preferred aldehydes from the group of the aliphatic aldehydes having 1 to 15 carbon atoms are formaldehyde, acetaldehyde, propionaldehyde and most preferably butyraldehyde, or a mixture of butyraldehyde and acetaldehyde. The aromatic aldehydes used may, for example, be benzaldehyde or derivatives thereof.

For the acetalization, the partly or fully hydrolysed polyvinyl acetates are dissolved or slurried in the appropriate aldehyde or aldehyde mixture. Typically, the partly or fully hydrolysed polyvinyl acetates are used in an amount of 5 to 30% by weight based on the total weight of the solution or slurry. The acetalization is effected in the presence of acidic catalysts such as hydrochloric acid, sulphuric acid, nitric acid or phosphoric acid. Preference is given to adjusting the pH to values of <1 by addition of 20% hydrochloric acid. The acetalization is carried out at a temperature of 20° C. to 60° C., preferably under reflux. Optionally, after the mixture has been cooled, the mixture is neutralized by addition of base and the excess aldehyde is distilled off.

The thus obtained polyvinyl acetals are subsequently dissolved in alcohol, preferably methanol or ethanol, and precipitated by means of lowering the temperature to <5° C., preferably <0° C., and isolated by means of filtration.

It is possible by the inventive procedure to obtain polyvinyl acetals which are notable for a very low OH number (high degree of acetalization), low viscosity and very good solubility in organic solvents. The OH number is preferably 4 to 12, preferably 4 to 8 (titration method to ASTM D 1396).

The polyvinyl acetals obtainable by the inventive procedure find use as a film in safety glass and as an acoustic film, as binders in printing inks, as binders in primers, as binders in corrosion protectants, as binders in the ceramics industry, especially as binders for green ceramic bodies. Mention should also be made of the use as binders for ceramic powders and metal powders in powder injection moulding, as binders for glass fibres and as binders for the interior coating of cans, if appropriate in combination with crosslinkers such as epoxy resins.

The examples which follow serve to further illustrate the invention without restricting it in any way:

### EXAMPLE 1

120 g of a polyvinyl alcohol having a degree of hydrolysis of 98% and a Höppler viscosity (DIN 53015, 4% in water) of 3.4 were slurried in 1250 ml of butyraldehyde. At internal temperature 67° C., 15 ml of a 10% HCl solution were added dropwise with stirring within 5 minutes. The reaction began very vigorously.

Afterwards, the mixture was boiled at reflux for a further 60 minutes. After cooling to room temperature, the neutralization was effected with 15 ml of a 10% NaOH solution.

The almost solidified melt was dissolved in ethanol, and the solids content was adjusted to 10%. Subsequently, the mixture was cooled initially to −1° C. and the temperature was subsequently lowered further to −5° C. During this time, 600 ml of a 10% KHCO₃ solution were added dropwise. The polyvinyl butyral precipitated out in fine, white form. The OH number (titration method, to ASTM D 1396) was 4; the viscosity of the 10% ethanol solution of the product (Höppler method) was 11.2 mPas.

### EXAMPLE 2

Analogous to Example 1 with the difference that a polyvinyl alcohol having a degree of hydrolysis of 98 mol % and a Höppler viscosity (DIN 53015, 4% in water) of 2.9 was used.

The OH number of the end product (titration method, to ASTM D 1396) was 8; the viscosity of the 10% ethanol solution of the product (Höppler method) was 9.6 mPas.

### EXAMPLE 3

Analogous to Example 1 with the difference that a polyvinyl alcohol having a degree of hydrolysis of 98 mol % and a Höppler viscosity (DIN 53015, 4% in water) of 4.1 was used.

The OH number of the end product (titration method, to ASTM D 1396) was 8; the viscosity of the 10% ethanol solution of the product (Höppler method) was 13.5 mPas.

### EXAMPLE 4

The procedure was analogous to Example 1, with the difference that all components were mixed together at room temperature and heated initially to 50° C. The suspension was converted to a viscous, clear solution which became mobile after 5 minutes. Afterwards, the reaction was conducted to completion under reflux over one hour and then, after cooling, worked up and precipitated according to Example 1.

The OH number of the end product (titration method, to ASTM D 1396) was 6; the viscosity of the 10% ethanol The OH number of the end product (titration method, to solution of the product (Höppler method) was 12.0 mPas.

### COMPARATIVE EXAMPLE 5

120 g of the polyvinyl alcohol from Example 1 were initially charged together with 500 ml of water and stirred with 125 ml of HCl (10%) and cooled to 0° C. 100 ml of butyraldehyde were then metered in over 45 minutes, then the suspension was kept at 0° C. for a further 40 minutes before it was then heated to 25° C. within 100 minutes. At this temperature, reaction was continued to completion for 90 minutes. The mixture was then filtered and washed with water, and the product was dried.

The OH number of the end product (titration method, to ASTM D 1396) was 18; the viscosity of the 10% ethanol solution of the product (Höppler method) was 25 mPas.

### COMPARATIVE EXAMPLE 6

The procedure was analogous to Comparative Example 5, with the difference that the polyvinyl alcohol from Example 2 was used.

The OH number of the end product (titration method, to ASTM D 1396) was 18; the viscosity of the 10% ethanol solution of the product (Höppler method) was 16 mPas.

### COMPARATIVE EXAMPLE 7

The procedure was analogous to Comparative Example 5, with the difference that the polyvinyl alcohol from Example 3 was used.

The OH number of the end product (titration method, to ASTM D 1396) was 18; the viscosity of the 10% ethanol solution of the product (Höppler method) was 40 mPas.

The comparison of Example 1, Example 4 with Comparative Example 5, and the comparison of Example 2 with Comparative Example 6 or the comparison of Example 3 with Comparative Example 7, shows that a substantially higher degree of acetalization (lower OH number) and lower viscosity of the end product are obtained with the process according to the invention for the same polyvinyl alcohol reactant than in the standard process for acetalization in aqueous solution/suspension.

TABLE 1

| | | Viscosity |
|---|---|---|
| Example | OH number | [mPas] |
| Example 1 | 4 | 11.2 |
| Comparative Example 5 | 18 | 25 |
| Example 2 | 8 | 9.6 |
| Comparative Example 6 | 18 | 16 |
| Example 3 | 8 | 13.5 |
| Comparative Example 7 | 18 | 40 |
| Example 4 | 6 | 12 |

1.-12. (canceled)

13. A process for the preparation of polyvinyl acetals, comprising acetalizing partly hydrolysed or fully hydrolysed vinyl ester polymers with at least one aldehyde having 1 to 15 carbon atoms, wherein the vinyl esters comprise unbranched or branched C₁₋₁₅ alkylcarboxylic acids and the vinyl ester polymers have ≧50 mol % of vinyl alcohol units, wherein the partly hydrolysed or fully hydrolysed vinyl ester polymers are dissolved or slurried in the aldehyde used for acetalizing.

14. The process of claim 13, wherein the vinyl ester polymers contain polymerized vinyl esters selected from the group consisting of vinyl acetate, vinyl propionate, vinyl butyrate, vinyl 2-ethylhexanoate, vinyl laurate, vinyl pivalate and vinyl esters of a-branched monocarboxylic acids having 5 to 11 carbon atoms.

15. The process of claim 13, wherein at least one aldehyde is selected from the group consisting of formaldehyde, acetaldehyde, propionaldehyde, and butyraldehyde.

16. The process of claim 14, wherein at least one aldehyde is selected from the group consisting of formaldehyde, acetaldehyde, propionaldehyde, and butyraldehyde.

17. The process of claim 13, wherein the degree of hydrolysis of the partly hydrolysed or fully hydrolysed vinyl ester polymers is ≧50 mol %.

18. The process of claim 17, wherein the degree of hydrolysis of partly hydrolysed polyvinyl esters is 70 to 90 mol % and the degree of hydrolysis of fully hydrolysed polyvinyl esters is ≧96 mol %.

19. The process of claim 13, wherein acetalizing is carried out until products having an OH number of 4 to 12 are obtained.

20. The process of claim 13, further comprising forming a film of said polyvinyl acetal and employing said film as a film in safety glass or as an acoustic film.

21. The process of claim 15, further comprising formulating said polyvinyl acetal as a binder in a printing ink, primer or corrosion protectant.

22. The process of claim 13, further comprising adding said polyvinyl metal to a ceramic composition as a binder.

23. The process of claim 13, further comprising adding to said polyvinyl acetal at least one powder selected from ceramic powders and metal powders.

24. The process of claim 13, further comprising applying said polyvinyl acetal to the inside of a can with a crosslinker, and crosslinking to form an interior coating on the can.

25. The process of claim 13, further comprising adding said polyvinyl acetal to glass fibers as a binder.
